(19) United States
(12) Patent Application Publication
(10) Pub. No.: US 2016/0206150 A1
(43) Pub. Date: Jul. 21, 2016

(54) PRE-SOAKED PACKAGED WOODEN PLANKS AND METHODS THEREFOR

(71) Applicants: Eric J. Wangler, Mendon, NY (US); David P. Prior, Rochester, NY (US)

(72) Inventors: Eric J. Wangler, Mendon, NY (US); David P. Prior, Rochester, NY (US)

(21) Appl. No.: 14/966,877

(22) Filed: Dec. 11, 2015

Related U.S. Application Data
(60) Provisional application No. 62/104,152, filed on Jan. 16, 2015.

(51) Int. Cl. A47J 37/07; B65D 81/22; B65B 53/00; B65D 75/00; B65B 31/02; B65B 51/10

(52) U.S. Cl. CPC A47J 37/0786; B65B 31/024; B65B 51/10; B65B 53/00; B65D 75/002; B65D 81/22

(57) ABSTRACT

A device for supporting and flavoring a food during cooking, such as grilling, baking or roasting, including a packaging structure with an interior; and a wooden plank removably located within the packaging structure interior; wherein the wooden plank includes a quantity of liquid such as water, broth or juice. The wooden plank is made of a food-safe wood, such as but not limited to oak wood, maple wood, pine wood, cedar wood, alder wood, cherry wood, hickory wood or ash wood. The wooden plank is pre-soaked in the liquid, such that the wooden plank smolders during the cooking process, thereby smoking the food. The pre-soaked wooden plank is packaged, so that is will not dry out substantially before use by the user.

### CROSS-REFERENCE TO RELATED APPLICATIONS

This application claims priority to U.S. Provisional Application No. 62/104,152, filed Jan. 16, 2015, which is incorporated herein by reference in its entirety.

### BACKGROUND OF THE INVENTION

A device for supporting and flavoring food during cooking, such as grilling, baking or roasting, including a packaging structure with an interior; and a wooden plank removably located within the packaging structure interior; wherein the wooden plank includes a quantity of liquid such as water, broth or juice. The wooden plank is made of wood, such as oak, maple, pine, cedar, alder, cherry, hickory or ash. The wooden plank is pre-soaked in the liquid, such that the wooden plank smolders during the cooking process, thereby smoking the food. The pre-soaked wooden plank is packaged, so that it will not dry out substantially before use by the user.

Cooking food on hot wooden planks is a well known method of preparing food that is becoming more popular. “Wood plank cooking” traditionally arises from the Pacific Northwest Native art of plank-grilling, an ancient tradition of cooking sides of fresh fish—specifically salmon—on alder wood or cedar. Plank-grilling fish and other foods on sections of soaked aromatic woods set over a grill is a very complex culinary experience. As the food cooks, essentially basting itself in its own oils and juices, it absorbs fragrant wood smoke to achieve a layering of flavors not found in any other form of cooking.

In order to properly use a wooden plank to prepare and cook food, the plank must be thoroughly soaked in water or other liquid, such as juice, cider, broth or wine, for anywhere from about twenty minutes to six hours or longer. For shorter time periods, typically the plank will be held under running water in a sink or placed in a pan or other container of water, resulting in under-soaking which can create fire hazards. For longer soaking periods, typically the plank is placed into a pan or bucket and some weight is placed on the wood to keep it submerged. This may result in uneven soaking as one end of the board lifts up, or even an entire side of the board if the weight holding the board down shifts entirely. Additionally, the area of the plank underneath the weight may not absorb liquid or flavors effectively. Proper soaking requires even soaking for the entire time period, so as to produce the optimal amount of smoke for food cooking and flavor without the risk of a fire. Pre-soaked wood that can be stored on the shelf for a period of time is more efficient and saves time by avoiding the soaking process entirely.

### SUMMARY OF THE INVENTION

In one embodiment, a device for supporting and flavoring a food during cooking, is provided and includes a packaging structure with an interior, and a wooden plank that is removably located within the packaging structure interior, wherein the wooden plank has a quantity of a liquid.

In a further embodiment, the device includes at least one additional wooden plank.

In a further embodiment, the packaging structure is one of water-resistant, waterproof and air-resistant. In another further embodiment, the packaging structure is food-safe. In yet another further embodiment, the packaging structure includes one or more of plastic, paper and metal foil. In still another further embodiment, the packaging structure is a shrink-wrap.

In a further embodiment, the packaging structure is adapted to substantially prevent loss of liquid, so as to substantially prevent the wooden plank from drying out.

In a further embodiment, the wooden plank is oak, maple, pine, cedar, alder, hickory, ash, cherry, apple or pear. In yet another further embodiment, the wooden plank is roasted. In still another further embodiment, the wooden plank is adapted to support a food during cooking. In still another further embodiment, the wooden plank is sized and shaped to support a quantity of food during cooking.

In a further embodiment, the wooden plank is at least partially permeated with the liquid. In another further embodiment, the wooden plank includes a quantity of the liquid sufficient to suppress at least some combustion thereof. In still another further embodiment, the wooden plank includes a quantity of the liquid sufficient to cause the wooden plank to smolder when placed over a fire. In yet another further embodiment, the wooden plank is adapted for cooking a food on a gas grill, a charcoal grill, a wood fire or in the oven.

In some embodiments, the liquid includes water. In some embodiments, the liquid includes a flavoring. In some embodiments, the liquid includes a preservative.

In second embodiment, a method of making a device for supporting and flavoring a food during cooking is provided, the method including the steps of providing a wooden plank and a quantity of liquid; submerging the wooden plank in the quantity of liquid for a period of time, whereby at least some of the liquid penetrates the wooden plank; and packaging the wooden plank in a packaging structure adapted to substantially prevent evaporation of the liquid that penetrated the wooden plank.

In a further embodiment, the step of submerging the wooden plank in the quantity of liquid includes soaking the wooden plank in the quantity of liquid.

In a further embodiment, the step of providing a wooden plank includes providing a wooden plank that is oak wood, maple wood, pine wood, cedar wood, alder wood, hickory wood, ash wood, cherry wood, apple wood or pear wood.

In a further embodiment, the step of providing a quantity of liquid includes providing a quantity of water. In a still further embodiment, the step of providing a quantity of water includes providing a flavoring.

In a further embodiment, the step of packaging the wooden plank includes providing the packaging structure. In a still further embodiment, the packaging structure is a re-sealable bag, such as a plastic bag.

In a third embodiment, a method of making a pre-soaked wooden plank for supporting and flavoring a food during cooking is provided, including the step of saturating a plurality of pre-cut wooden planks.

In a further embodiment, the step of saturating the plurality of pre-cut wooden planks includes at least one of static batch vat soaking, large batch steam pressure chamber treatment and serpentine conveyance through a tank of liquid.

In a further embodiment, the method includes placing the soaked planks in a oxygen barrier polybag; placing the polybags with the planks in a vacuum chamber; removing the excess air from the polybag; and heat sealing the polybag.

In a further embodiment, the method includes placing the soaked planks onto a conveyor with two rolls of barrier film above and below the plank; transporting the planks into an automated scaling device wherein the bag is sealed on three side; drawing a vacuum; and sealing the fourth side.

In a further embodiment, the method includes purging ambient air from the bag with gas prior to vacuum and final seal, whereby preservation of the plank is extended by minimizing bacterial growth.

In a further embodiment, the method is automated.

In a further embodiment, each plank is individually packages and then several packages are enclosed in a retail appropriate package for sale.

In a further embodiment, the method includes adding natural or artificial flavor to the liquid for soaking the planks.

The drawings constitute a part of this specification and include exemplary embodiments of the present invention and illustrate various objects and features thereof.

### BRIEF DESCRIPTION OF THE DRAWINGS

FIG. 1 is a perspective view of pre-soaked wooden planks supporting food on a charcoal grill.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

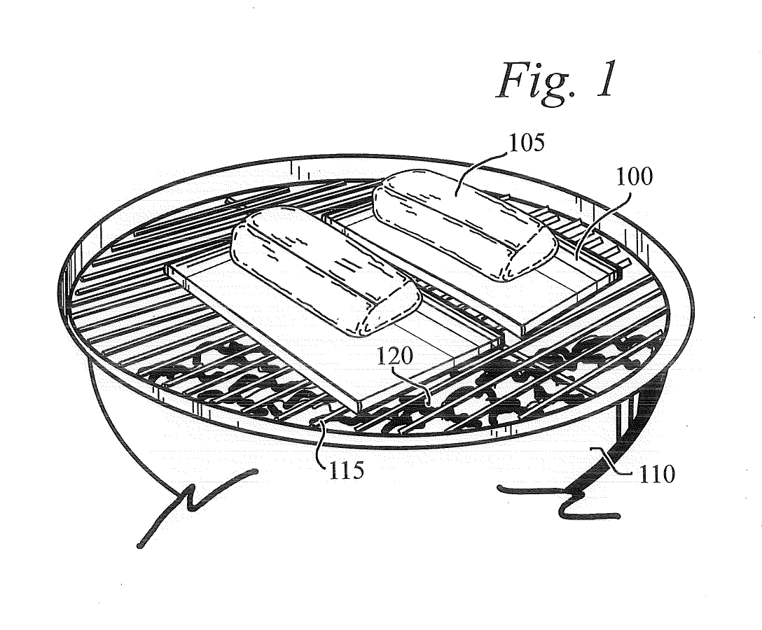

FIG. 1 illustrates a device for supporting and optionally flavoring a food during cooking. The device includes a packaging structure (not shown) with an interior; and a wooden plank, denoted by the numeral 100, removably located within the interior of the packaging structure; wherein the wooden plank 100 includes a quantity of liquid. As shown in FIG. 1, the wooden plank 100 is adapted to support a quantity, or piece, of food 105 during cooking, such as cooking over a grill 110. In the illustrated embodiment, the grill 100 includes a grate 115 that receives the wooden plank 100 thereon and supports the wooden plank 100 above a heat source, such as but not limited to a charcoal fire 120 or a gas fire. Alternatively, the wooden plank 100 can be placed onto a baking sheet into a pan, and the cooking can be performed by baking in an oven, cooking over an open camp fire or the like. Such cooking methods are commonly referred to as “planking” or “grilling on a wooden plank.” It is foreseen that the wooden plank 100 can be replaced by a wooden skewer (not shown).

In some circumstances, one, two, three, four, five or more wooden planks 100 are packaged together for sale to the end user. It is foreseen that the package may or may not contain soaking liquid. When the package includes the soaking liquid, the planks 100 will be soaked prior to purchase by the user. When the package does not included the soaking liquid, planks 100 will be dry and the user will be able to add soaking liquid to the package of planks 100 at a later time, so as to soak the planks 100 at that time.

In circumstances wherein a plurality of wooden planks 100 are sold in a package, each of the wooden planks 100 may be individually wrapped, and then the plurality of individually wrapped planks 100 are packaged, wrapped, bundled or bound together. This enables the user to use one individually wrapped wooden plank 100 at a time, while the remaining individually wrapped wooden planks 100 are prevented from drying out in the opened package. In other circumstances, a plurality of wooden planks 100 are packaged together in a re-sealable package. It is foreseen that additional planks 100 may be added to the package when the package is re-sealable. It is foreseen that a plurality of individually wrapped, pre-soaked wood skewers may also be sold in the package.

Generally, the packaging structure is one of water-resistant, waterproof and air-resistant. The terms “water-resistant” and “waterproof,” as used herein, are broad terms and are used in its ordinary sense, including, without limitation, being relatively unaffected by water, such as resisting the egress of water from unopened packaging, such as but not limited to egress by evaporation, during storage. Water-resistant and waterproof packaging as is known in the art. The term “air-resistant,” as used herein, is a broad term and is used in its ordinary sense, including, without limitation, being relatively unaffected by air, such as resisting the ingress or egress of air from unopened packaging during storage. Air-resistant packaging is known in the art. In some embodiments, the packaging structure is adapted to substantially prevent loss of liquid, so as to substantially prevent the wooden plank 100 from drying out.

The packaging structure is manufactured from a food-safe material, including but not limited to plastic, paper and metal foil. The term “food-safe,” as used herein, is a broad term and is used in its ordinary sense, including, without limitation, being suitable for contact with food as defined by described in the Code of Federal Legislation (CFR): 21 CFR 174-21 CFR 190. Food contact materials include but are not limited to plastics, rubber, paper, coatings and metals. For example, in many cases a combination of such materials is used to fabricate a package structure; for example a carton box for juices can include (from the inside to the outside): plastic layer, aluminum, paper, printing and top coating. In some circumstances, the packaging structure is a shrink-wrap.

The wooden plank 100 can be made using any type of wood, so long as the wood is a food-safe wood (i.e., not pressure treated wood or plywood). However, wood plank grilling is usually performed using an aromatic wood, such as cedar or fruit wood. Accordingly, in some embodiments, the wooden plank 100 is oak wood, maple wood, pine wood, cedar wood, alder wood, hickory wood, ash wood, cherry wood, apple wood or pear wood. The wooden plank 100 should not be made from woods that are not food-safe, such as wood derived from plants that a poisonous, toxic or noxious to humans or wood that has been soaked or coated in poisonous, toxic or noxious chemicals or substances.

In some circumstances, the wooden plank 100 may be treated to enhance flavor of the food during cooking. For example, the wooden plank 100 can be roasted, coated with one or more herbs, spices and salt, or soaked in a flavoring liquid such as but not limited to flavored water, juice, wine, cider or broth. Such flavoring techniques are known in the art.

Generally, the wooden plank 100 is sized and shaped, or otherwise adapted, to support food during cooking. Common plank shapes include elongated, flat planks of wood. In some circumstances, the plank 100 is circular or an oval, and is generally short and flat, with a width and length sufficient to support a desired quantity of food. In other circumstances, the planks 100 have short, flat rectangular or polygonal shapes. Typically, the plank 100 is shaped to hold a specific quantity of food, such as a fish fillet, a chicken breast, a steak or a hamburger. In some circumstances, the plank 100 is sized to support multiple pieces of food. In some circumstances, the plank 100 is sized and shaped to be received by a coordinating platter or pan, such as but not limited to a decorative serving platter. Such platters and pans may or may not be suitable for use in the oven.

As noted above, the wooden plank 100 is soaked in a liquid. Generally, the wooden plank 100 is at least partially permeated or infused with the liquid. Accordingly, the liquid diffuses a distance into the wood. The distance that the liquid diffuses into the liquid depends upon several factors, such as but not limited to the type of wood used, the type of liquid used, the length of the soaking time, the temperature and the pressure. In some embodiments, the liquid diffuses into the wood a distance of about one-sixteen of an inch, about one-eighth of an inch, about one-fifth of an inch, about one-fourth of an inch, about one-third of an inch, about one-half of an inch, about two-thirds of an inch, about three-fourths of an inch, about an inch, or farther, wherein the distance is measured from the nearest surface of the wooden plank 100.

The wooden planks 100 can be soaked for various periods, durations or lengths of time from about 20-minutes or less up to about 120-minutes or longer. For example, the wooden planks 100 can be soaked for about 30-minutes, about 40-minutes, about 50-minutes, about 60-minutes, about 70-minutes, about 80-minutes, about 90-minutes, about 100-minutes or about 110-minutes.

Generally, the wooden plank 100 is soaked such that it includes a quantity of the liquid that is sufficient to suppress at least some combustion thereof. For example, the quantity of liquid included in the wooden plank 100 is sufficient to suppress at least some combustion of the wooden plank 100 when the food is being cooked thereon, such as when being grilled. In some embodiments, the wooden plank 100 includes a quantity of the liquid sufficient to cause the wooden plank 100 to smolder when placed over a fire. When the wooden plank 100 smolders, a fragrant smoke is produced. The fragrant smoke generally permeates and flavors the food being cooked on the wooden plank 100.

Generally, the wooden plank 100 is adapted for cooking a piece of food on a gas grill, on a charcoal grill 110, on a wood fire or in the oven, such as is known in the art.

A variety of liquids can be used to soak the wooden plank 100. Some liquids, such a water, only moisten the wooden plank 100 and do not substantially impart flavors thereto. Some liquids, such as juice, cider or wine impart flavors to the wooden plank 100. Liquids that impart flavor to the wooden plank 100 can impart flavor to the food that is cooked on the wooden plank 100, such as by the smoke created as the plank 100 burns, chars, smoked or smolders, such as is known in the art. In some circumstances, the liquid includes a flavoring, such as herbs, spices, salts, vinegar, juice or a flavor extract. In some circumstances, the liquid includes a preservative. It is foreseen that a preservative may be included in the soaking liquid, to preserve the soaked wooden plank 100 for a period of time, such as the storage time, before the end of which the plank 100 should be used by the end user.

In another embodiment, wooden skewers (not shown) are used instead of wood planks 100. The skewers, which can be fabricated similarly to the planks 100 using any wood or method described herein, are packaged with a soaking liquid, such as is described herein. Packaged pre-soaked skewers provide convenience and time savings by providing the user with a readily available, shelf-stable source of skewers that the user does not have to soak prior to use.

In another embodiment, a method of making a device for supporting and flavoring a food during cooking is provided. The method includes the steps of providing a wooden plank 100 and a quantity of liquid, such as is described above; submerging the wooden plank 100 in the quantity of liquid for a period of time, such as is described above, whereby at least some of the liquid penetrates the wooden plank 100; and packaging the wooden plank 100 in a packaging structure adapted to substantially prevent evaporation of the liquid that penetrated the wooden plank 100.

In some embodiments, the step of submerging the wooden plank 100 in the quantity of liquid includes soaking the wooden plank 100 in the quantity of liquid.

In some embodiments, the step of providing a wooden plank 100 includes providing a wooden plank 100 selected from the group consisting of oak wood, maple wood, pine wood, cedar wood, alder wood, hickory wood, ash wood, cherry wood, apple wood and pear wood.

In some embodiments, the step of providing a quantity of liquid includes providing a quantity of water. For example, in some embodiments, providing a quantity of water includes providing a flavoring, such as but not limited to a flavoring described above.

In some embodiments, packaging the wooden plank 100 includes providing the packaging structure.

In another embodiment a method of making a pre-soaked wooden plank for supporting and flavoring a food during cooking is provided, including saturating a plurality of pre-cut wooden planks 100, such as the planks 100 described above.

In some circumstances, the step of saturating the plurality of pre-cut wooden planks 100 includes at least one of static batch vat soaking, large batch steam pressure chamber treatment and serpentine conveyance through a tank of liquid, such as is known in the art.

In some embodiments, the planks 100 are placed in an oxygen barrier polybag, such as is known in the art. Then the plank-filled polybags are placed, with the planks, in a vacuum chamber; followed by removing the excess air from the polybags; and then heat sealing the polybags.

In some embodiments, the soaked planks 100 are placed onto a conveyor with two rolls of barrier film, wherein one roll is above and the other below the planks 100; then transporting the planks 100 into an automated scaling device, such as is known in the art, wherein the bag is sealed on three side; then drawing a vacuum; and sealing the fourth side.

In some further embodiments, the ambient air is purged from the bag with a gas prior to vacuuming and the final seal of the polymer bags (i.e., polybags), whereby the planks 100 are preserved for an extended time by minimizing bacterial growth therein, such as is known in the art.

In some embodiments, the method is automated. In other embodiments, some or all steps of the method are performed by hand.

In a further embodiment, each plank 100 is individually package and then several packages of planks 100 are enclosed in a retail appropriate package for sale to the consumer or end user.

In a further embodiment, natural or artificial flavor is added to the liquid for soaking the planks 100.

It is to be understood that while certain forms of the present invention have been illustrated and described herein, it is not to be limited to the specific forms or arrangement of parts described and shown.

What is claimed and desired to be secured by Letters Patent is as follows:

1. A device for supporting and flavoring a food during cooking, comprising:
a) a packaging structure including an interior; and
b) a wooden plank removably located within the packaging structure interior; wherein
c) the wooden plank includes a quantity of liquid.

2. The device of claim 1, further comprising:
a) at least one additional wooden plank.

3. The device of claim 1, wherein:
a) the packaging structure is one of water-resistant, waterproof and air-resistant.

4. The device of claim 1, wherein:
a) the packaging structure is food-safe.

5. The device of claim 1, wherein:
a) the packaging structure includes one or more of plastic, paper and metal foil.

6. The device of claim 1, wherein:
a) the packaging structure is a shrink-wrap.

7. The device of claim 1, wherein:
a) the packaging structure is adapted to substantially prevent loss of liquid, so as to substantially prevent the wooden plank from drying out.

8. The device of claim 1, wherein:
a) the wooden plank includes a food-safe wood.

9. The device of claim 1, wherein:
a) the wooden plank is selected from the group consisting of oak wood, maple wood, pine wood, cedar wood, alder wood, hickory wood, ash wood, cherry wood, apple wood and pear wood.

10. The device of claim 1, wherein:
a) the wooden plank is roasted.

11. The device of claim 1, wherein:
a) the wooden plank is adapted to support a food during cooking.

12. The device of claim 1, wherein:
a) the wooden plank is sized and shaped to support a quantity of food during cooking.

13. The device of claim 1, wherein:
a) the wooden plank is at least partially permeated with the liquid.

14. The device of claim 1, wherein:
a) the wooden plank includes a quantity of the liquid sufficient to suppress at least some combustion thereof.

15. The device of claim 1, wherein:
a) the wooden plank includes a quantity of the liquid sufficient to cause the wooden plank to smolder when placed over a fire.

16. The device of claim 1, wherein:
a) the wooden plank is adapted for cooking a food by one of a gas grill, a charcoal grill, a wood fire and in the oven.

17. The device of claim 1, wherein:
a) the liquid includes water.

18. The device of claim 1, wherein:
a) the liquid includes a flavoring.

19. The device of claim 1, wherein:
a) the liquid includes a preservative.

20. A method of making a device for supporting and flavoring a food during cooking, the method comprising:
a) providing a wooden plank and a quantity of liquid;
b) submerging the wooden plank in the quantity of liquid for a period of time, whereby at least some of the liquid penetrates the wooden plank; and
c) packaging the wooden plank in a packaging structure adapted to substantially prevent evaporation of the liquid that penetrated the wooden plank.

21. The method according to claim 20, wherein:
a) the step of submerging the wooden plank in the quantity of liquid includes soaking the wooden plank in the quantity of liquid.

22. The method according to claim 20, wherein:
a) providing a wooden plank includes providing a wooden plank selected from the group consisting of oak wood, maple wood, pine wood, cedar wood, alder wood, hickory wood, ash wood, cherry wood, apple wood and pear wood.

23. The method according to claim 20, wherein:
a) providing a quantity of liquid includes providing a quantity of water.

24. The method according to claim 23, wherein:
a) providing a quantity of water includes providing a flavoring.

25. The method according to claim 20, wherein:
a) packaging the wooden plank includes providing the packaging structure.

26. A method of making a pre-soaked wooden plank for supporting and flavoring a food during cooking, the method comprising:
a) saturating a plurality of pre-cut wooden planks.

27. The method of claim 26, wherein:
a) the step of saturating the plurality of pre-cut wooden planks includes at least one of static batch vat soaking, large batch steam pressure chamber treatment and serpentine conveyance through a tank of liquid.

28. The method of claim 26, further comprising:
a) placing the soaked planks in a oxygen barrier polybag;
b) placing the polybag with the planks in a vacuum chamber;
c) removing the excess air from the polybag; and
d) heat sealing the polybag.

29. The method of claim 26, further comprising:
a) placing the soaked planks onto a conveyor with two rolls of barrier film above and below the plank;
b) transporting the planks into an automated scaling device wherein the bad is seals on three side;
c) drawing a vacuum; and
d) sealing the fourth side.

30. The method of claim 26, further comprising:
a) purging ambient air from the bag with gas prior to vacuum and final seal, whereby preservation of the plank is extended by minimizing bacterial growth.

31. The method of claim 26, wherein:
a) the method is automated.

32. The method of claim 26, wherein:
a) each plank is individually packages and then several packages are enclosed in a retail appropriate package for sale.

33. The method of claim 26, further comprising:
a) adding natural or artificial flavor to the liquid for soaking the planks.

34. A device for supporting a food during cooking, comprising:
a) a packaging structure including an interior; and
b) a plurality of wooden skewers removably located within the packaging structure interior; wherein
c) the skewers includes a quantity of liquid.

35. The device of claim 34, wherein:
a) the packaging structure is one of water-resistant, waterproof and air-resistant.

36. The device of claim 34, wherein:
a) the packaging structure is food-safe.

37. The device of claim 34, wherein:
a) the packaging structure includes one or more of plastic, paper and metal foil.

38. The device of claim 34, wherein:
a) the packaging structure is a shrink-wrap.

39. The device of claim 34, wherein:
a) the packaging structure is adapted to substantially prevent loss of liquid, so as to substantially prevent the skewers from drying out.

40. The device of claim 34, wherein:
a) the skewer include a food-safe wood.

41. The device of claim 34, wherein:
a) the skewers are formed from one of oak wood, maple wood, pine wood, cedar wood, alder wood, hickory wood, ash wood, cherry wood, apple wood and pear wood.

42. The device of claim 34, wherein:
a) the skewers are at least partially permeated with the liquid.

43. The device of claim 34, wherein:
a) the skewers include a quantity of the liquid sufficient to suppress at least some combustion thereof.

44. The device of claim 34, wherein:
a) the liquid includes water.

45. The device of claim 34, wherein:
a) the liquid includes a flavoring.

46. The device of claim 34, wherein:
a) the liquid includes a preservative.
